(19) United States
(12) Patent Application Publication
(10) Pub. No.: US 2014/0137480 A1
(43) Pub. Date: May 22, 2014

(54) DOOR SASH FOR VEHICLE AND MANUFACTURING METHOD THEREOF

(71) Applicants: HISADA CO., LTD., Anjo-shi (JP); AISIN SEIKI KABUSHIKI KAISHA, Kariya-shi (JP)

(72) Inventors: Eisuke SATO, Nagoya-shi (JP); Masahiro Hashiguchi, Toyota-shi (JP); Masashi Saeki, Toyota-shi (JP)

(73) Assignees: HISADA CO., LTD., Anjo-shi (JP); AISIN SEIKI KABUSHIKI KAISHA, Kariya-shi (JP)

(21) Appl. No.: 14/084,062

(22) Filed: Nov. 19, 2013

(30) Foreign Application Priority Data
Nov. 21, 2012 (JP) 2012-255600

(51) Int. Cl. B60J 10/04; B60J 1/17

(52) U.S. Cl. CPC B60J 10/042; B60J 1/17
USPC 49/406; 29/897.2

(57) ABSTRACT

A door sash for a vehicle includes a column portion extending in an elongated configuration from a door panel of the vehicle towards an upper direction, wherein the column portion includes a main portion made of a piece of metal plate, the main portion including a recessed portion which is recessed in a vehicle width direction and is formed in a long-side direction of the main portion, the column portion includes a glass run channel portion made of a piece of metal plate, the glass run channel portion being assembled on the main portion, the glass run channel portion including a cover portion, the recessed portion is configured so that a depth of a recess thereof is reduced from a portion thereof which is positioned at an upper surface of the door panel towards the upper direction, and a weather strip channel portion is formed at the main portion.

### CROSS REFERENCE TO RELATED APPLICATIONS

This application is based on and claims priority under 35 U.S.C. §119 to Japanese Patent Application 2012-255600, filed on Nov. 21, 2012, the entire content of which is incorporated herein by reference.

### TECHNICAL FIELD

This disclosure generally relates to a door sash for a vehicle and a manufacturing method thereof.

### BACKGROUND DISCUSSION

A known door sash for a vehicle is provided at an upper portion of a door panel of the vehicle. The known door sash for the vehicle includes a column portion which extends in an elongated configuration from an upper surface of the door panel of the vehicle towards an upper direction.

A known door sash for a vehicle disclosed in JP2010-105531A (hereinafter referred to as Patent reference 1) is provided with a column portion including a closed cross section-shaped portion where a cross section that is orthogonal to a long-side direction is closed. The closed cross section-shaped portion of the known door sash for the vehicle is formed so that a length in a vehicle width direction is gradually reduced from a portion positioned at the upper surface of the door panel towards the upper direction. In addition, the column portion of the known door sash for the vehicle includes a main portion, a glass run channel portion and a weather strip channel portion, which are made of separate metal plates from each other and are formed by bending respective metal plates. That is, the column portion of the known door sash for the vehicle, which is disclosed in Patent reference 1, is formed by bending the three metal plates separately or individually and by joining the three metal plates to one another thereafter.

According to the known door sash for the vehicle disclosed in Patent reference 1, material costs are high because the column portion is formed by using the three pieces of metal plates, and workload is increased because the three parts are assembled.

A need thus exists for a door sash for a vehicle and a manufacturing method thereof, which is not susceptible to the drawback mentioned above.

### SUMMARY

According to an aspect of this disclosure, a door sash for a vehicle includes a column portion extending in an elongated configuration from an upper surface of a door panel of the vehicle towards an upper direction, wherein the column portion includes a main portion which is made of a piece of metal plate and is formed in an elongated configuration, the main portion including a recessed portion which is recessed in a vehicle width direction and is formed in a long-side direction of the main portion, the column portion includes a glass run channel portion which is made of a piece of metal plate and is formed in an elongated configuration, the glass run channel portion being assembled on the main portion in a manner that a long-side direction of the glass run channel portion coincides with the long-side direction of the main portion, the glass run channel portion including a cover portion covering an opening surface of the recessed portion, the glass run channel portion being configured to be mounted with a glass run for guiding movement of a door glass which is movably attached to the door panel, the recessed portion is configured so that a depth of a recess of the recessed portion is reduced from a portion thereof which is positioned at the upper surface of the door panel towards the upper direction, and a weather strip channel portion is formed at the main portion, and a weather strip for sealing a gap between a body of the vehicle and the column portion is configured to be attached to the weather strip channel portion.

According to another aspect of this disclosure, a method for manufacturing a door sash for a vehicle, the door sash configured to include a column portion extending in an elongated configuration from an upper surface of a door panel of the vehicle towards an upper direction, the column portion including a main portion which is made of a piece of metal plate and is formed in an elongated configuration, the main portion including a recessed portion which is recessed in a vehicle width direction and is provided in a long-side direction of the main portion, the column portion including a glass run channel portion which is made of a piece of metal plate and is formed in an elongated configuration, the glass run channel portion being assembled on the main portion in a manner that a long-side direction of the glass run channel portion coincides with the long-side direction of the main portion, the glass run channel portion including a cover portion covering an opening surface of the recessed portion, the glass run channel portion being configured to be mounted with a glass run for guiding movement of a door glass which is movably attached to the door panel, the method for manufacturing the door sash for the vehicle includes a roll process for forming an intermediate formed product by roll-forming a metal plate including an elongated shape, the intermediate formed product being formed in an elongated shape and including a constant cross-sectional configuration at which a weather strip channel portion is formed, a weather strip for sealing a gap between a body of the vehicle and the column portion being attached to the weather strip channel portion, and a press process for forming the recessed portion at an unrestrained portion which is not restrained, the recessed portion being recessed in a direction that is orthogonal to a long-side direction of the intermediate formed product and including a portion at which a depth of a recess is continuously changed in the long-side direction, wherein the unrestrained portion which is not restrained is pressed by a punch while a restrained portion including the weather strip channel portion formed at the intermediate formed product is restrained by a die in the press process.

### BRIEF DESCRIPTION OF THE DRAWINGS

The foregoing and additional features and characteristics of this disclosure will become more apparent from the following detailed description considered with the reference to the accompanying drawings, wherein;

FIG. 1 is a lateral view illustrating a vehicle door mounted on a vehicle, which is viewed from a vehicle inside, according to an embodiment disclosed here;

FIG. 2 is a front view illustrating a rear column portion of this embodiment, which is viewed from a front side in a vehicle front/rear direction;

FIG. 3 is a cross-sectional view taken along line III-111 in FIG. 1;

FIG. 4 is a cross-sectional view taken along line IV-IV in FIG. 1;

FIG. 5 is a view illustrating a roll forming apparatus for roll-forming a main portion of this embodiment;

FIG. 6 is a cross-sectional view of an intermediate formed product which is formed in a roll forming process of this embodiment;

FIG. 7 is a cross-sectional-view illustrating a die used in a press process of this embodiment;

FIG. 8A is a front view schematically illustrating a punch used in the press process;

FIG. 8B is a lateral view schematically illustrating the punch used in the press process;

FIG. 9A is a view indicating a state of deformation of the intermediate formed product which is press-formed in the press process, before the press-forming is performed;

FIG. 9B is a view indicating a state of deformation of the intermediate product which is press-formed in the press process, after the press-forming is performed;

FIG. 10A is a view illustrating a positional relation between the punch and the intermediate product before the press forming, which is viewed from a lateral direction;

FIG. 10B is a view illustrating a positional relation between the punch and the intermediate product after the press forming, which is viewed from the lateral direction;

FIG. 11 is a perspective view of the intermediate formed product which has undergone the press process;

FIG. 12 is a perspective view of a formed product which has undergone a trimming process of this embodiment;

FIG. 13 is a cross-sectional view of a rear column portion related to another example;

FIG. 14 is a cross-sectional view of the intermediate formed product at which a step is formed by roll-forming;

FIG. 15A is a view indicating a state of deformation of the intermediate formed product illustrated in FIG. 14 when the intermediate formed product is press-formed; and

FIG. 15B is a view indicating a state of deformation of the intermediate formed product illustrated in FIG. 14 when the intermediate formed product is press-formed.

### DETAILED DESCRIPTION

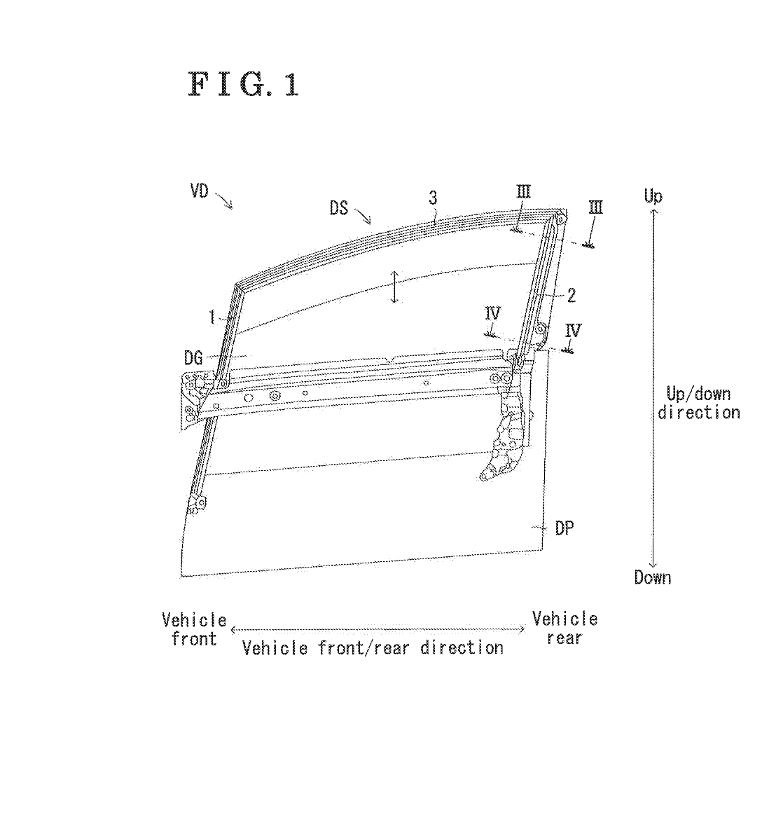

An embodiment disclosed here will be explained with reference to the drawings. FIG. 1 is a lateral view of a portion, which is related to this embodiment, of a vehicle door mounted on the vehicle, which is viewed from a vehicle inside. As illustrated in FIG. 1, a vehicle door VD includes a door panel DP, a door sash DS and a door glass DG.

As is well known, the door panel DP is formed to include an inner panel and an outer panel which are overlapped or assembled on with each other. The inner panel is not illustrated in FIG. 1. In the door panel DP, a window regulator apparatus is incorporated. The door glass DG, which is configured to advance above and retreat below the door panel DP, is assembled on the window regulator apparatus. As the window regulator apparatus is actuated, the door glass DG moves upwardly and downwardly as indicated by the arrow in FIG. 1.

The door sash DS is structured so as to surround an outer edge or a periphery of the door glass DG which has advanced, that is, moved upwardly, above the door panel DP. A glass run for guiding the movement of the door glass DG in an up/down direction is mounted on the door sash DS. Thus, the up/down movement of the door glass DG is guided by the door sash DS.

The door sash DS includes a front column portion 1, a rear column portion 2 and an upper portion connecting portion 3. The front column portion 1 is attached to an upper surface of the door panel DP, at a front end portion thereof in a vehicle front/rear direction. The rear column portion 2 is attached to the upper surface of the door panel DP, at a rear end portion thereof in the vehicle front/rear direction. The front column portion 1 is arranged at a front portion of the door panel DP in the vehicle front/rear direction so as to extend in the up/down direction. The rear column portion 2 is arranged at a rear portion of the door panel DP in the vehicle front/rear direction so as to extend in the up/down direction. The upper portion connecting portion 3 is formed to be curved in a convex configuration that is convexed upwardly, no as to connect an upper end of the front column portion 1 and an upper end of the rear column portion 2 to each other. The door glass DG advances to and retreats from a surrounded space portion which is surrounded by the front column portion 1, the rear column portion 2 and the upper portion connecting portion 3. In this embodiment, the rear column portion 2 serves as a column portion disclosed here.

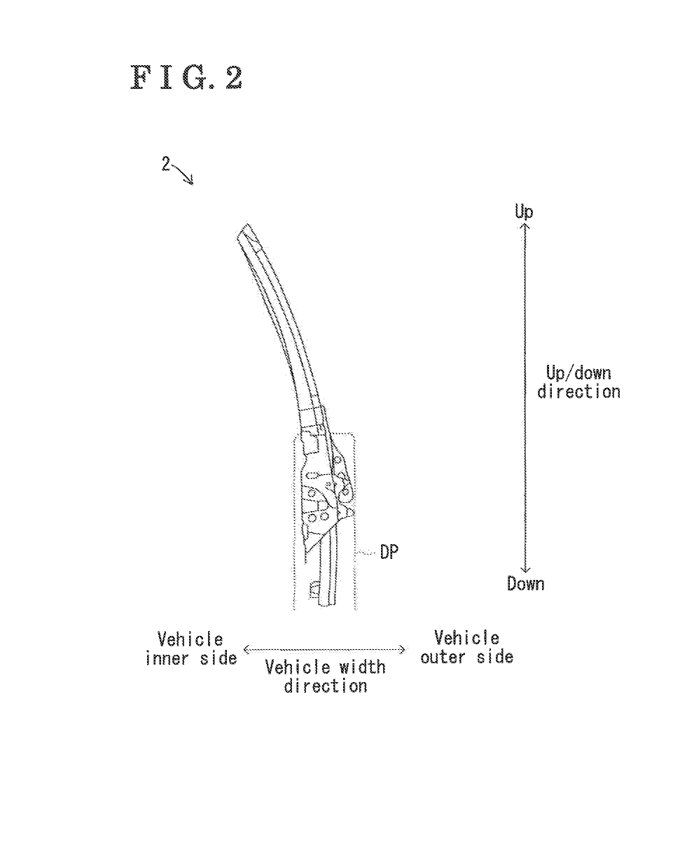

FIG. 2 is a front view of the rear column portion 2, which is viewed from a front side in the vehicle front/rear direction. As illustrated in FIG. 2, the rear column portion 2 extends in an elongated configuration from the upper surface of the door panel DP towards an upper direction. In addition, the rear column portion 2 is formed to be curved and inclined in a vehicle inner side from a portion which is positioned at the upper surface of the door panel DP towards the upper direction.

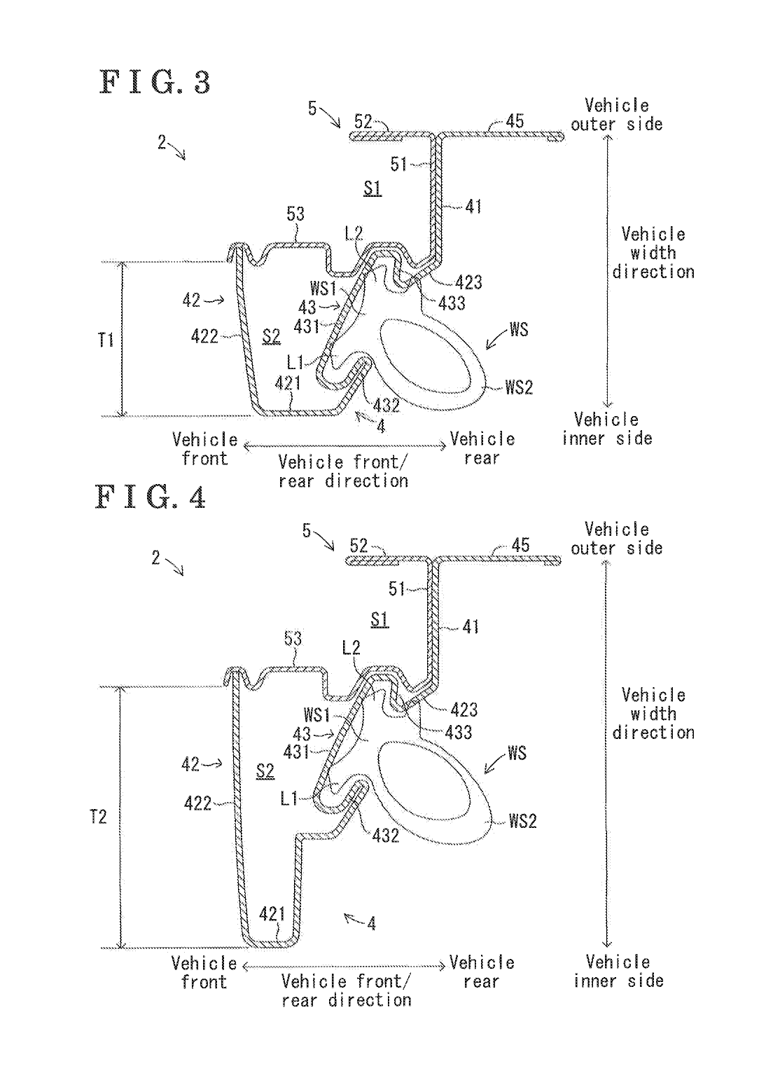

FIG. 3 is a cross-sectional view taken along line in FIG. 1, and FIG. 4 is a cross-sectional view taken along line IV-IV in FIG. 1. Each of FIGS. 3 and 4 illustrates a cross-sectional configuration of the rear column portion 2, which is orthogonal to a long-side direction thereof. In FIG. 3, the cross-sectional configuration of an upper portion of the rear column portion 2, which is close to the upper portion connecting portion 3, is illustrated. In FIG. 4, the cross-sectional configuration of a portion (the portion in a vicinity of a beltline of the vehicle) of the rear column portion 2, which is positioned at the upper surface of the door panel DP, is illustrated.

As illustrated in FIGS. 3 and 4, the rear column portion 2 includes a main portion 4 and a glass run channel portion 5. The main portion 4 is formed in an elongated configuration where a piece of metal plate including an elongated shape is bent or folded in a width direction thereof. The glass run channel portion 5 is formed in an elongated configuration where a piece of metal plate including an elongated shape is bent or folded in a width direction thereof. The glass run channel portion 5 includes a connecting wall portion 51, an outer wall portion 52 and an inner wall portion 53. The connecting wall portion 51 includes a flat surface that is orthogonal to the vehicle front/rear direction. The outer wall portion 52 extends from an end of the connecting wall portion 51 at the vehicle outer side towards the vehicle front side. The inner wall portion 53 extends from an end of the connecting wall portion 51 at the vehicle inner side towards the vehicle front side. The connecting wall portion 51, the outer wall portion 52 and the inner wall portion 53 form or define a space portion S1 opening towards the vehicle front side. The glass run is attached in the space portion S1.

The main portion 4 includes a horizontal wall portion 41, a recessed portion 42 and an outer wall portion 45. The horizontal wall portion 41 is overlapped with the connecting wall portion 51 of the glass run channel portion 5 so as to be along a surface, of the connecting wall portion 51, facing the vehicle rear direction. The recessed portion 42 is connected to an end of the horizontal wall portion 41 at the vehicle inner side, and is formed to be recessed towards the vehicle inner side (in the vehicle width direction). The outer wall portion 45 extends from an end of the horizontal wall portion 41 at the vehicle outer side towards the vehicle rear side. The recessed portion 42 includes a bottom portion 421, a front wall portion 422 and a rear wall portion 423. The bottom portion 421 is arranged at the vehicle inner side and includes a surface that is orthogonal to the vehicle width direction. The front wall portion 422 extends from a front end of the bottom portion 421 in the vehicle front/rear direction towards the vehicle outer side. The rear wall portion 423 is connected to an end of the horizontal wall portion 41 at the vehicle inner side and extends from a rear end of the bottom portion 421 in the vehicle front/rear direction towards the vehicle outer side. The bottom portion 421, the front wall portion 422 and the rear wall portion 423 form or define a space portion opening towards the vehicle outer side.

The glass run channel portion 5 is assembled on the main portion 4 in a manner that a long-side direction of the glass run channel portion 5 coincides with a long-side direction of the main portion 4. At this time, the glass run channel portion 5 is assembled on the main portion 4 in a manner that an opening portion (that is, an opening surface of the recessed portion 42) of the space portion which is defined by the bottom portion 421 the front wall portion 422 and the rear wall portion 423 of the main portion 4 and which opens towards the vehicle outer side is covered with the inner wall portion 53 (i.e., a cover portion) of the glass run channel portion 5. Accordingly, a closed space portion S2 surrounded by the inner wall portion 53 of the glass run channel portion 5, and the bottom portion 421, the front wall portion 422 and the rear wall portion 423 of the recessed portion 42 of the main portion 4 is formed. As explained above, because the closed space portion is formed in the rear column portion 2 in the long-side direction, a rigidity of the rear column portion 2 is enhanced.

A length of the closed space portion S2 in the vehicle width direction, that is, depth of the recessed portion 42 from the opening surface thereof, changes along the long-side direction of the main portion 4. A depth T1 of the closed space portion S2 (that is, the depth of the recessed portion 42) at a portion (a position that is away from the upper surface of the door panel DP) whose cross section is illustrated in FIG. 3 is shallower or smaller than a depth T2 of the closed space portion S2 at a portion (the position of the upper surface of the door panel DP) whose cross section is illustrated in FIG. 4. That is, the recessed portion 42 is formed to include a cross-sectional configuration with a gradual change in such a manner that the depth of the recessed portion 42 is gradually and continuously reduced towards the upper direction from the portion (the portion in a vicinity of the belt line) which is positioned at the upper surface of the door panel DP. Accordingly, also an area of the closed space portion S2 is reduced from the portion, of the closed space portion S2, which is positioned at the upper surface of the door panel DP towards the upper direction. Because the depth of the recessed portion 42 at the portion thereof positioned at the upper surface of the door panel DP is large (that is, the area of the closed space portion S2 is large), a mounting rigidity of the rear column portion 2 to the door panel DP is enhanced. In addition, because the depth of the recessed portion 42 is reduced (that is, the area of the closed space portion S2 is reduced) as a distance from the door panel DP increases in the upper direction, weight of the door sash DS may be reduced.

A weather strip channel portion 43 is formed at the rear wall portion 423 of the recessed portion 42. The weather strip channel portion 43 is formed as a recessed part that is recessed from the rear wall portion 423 towards the vehicle front side so as to open towards the vehicle rear side. A weather strip WS is attached to the weather strip channel portion 43. The weather strip WS is provided in order to seal a gap between a body of the vehicle and the rear column portion 2. The weather strip WS includes a support portion WS1 and a lip portion WS2. The support portion WS1 is attached to the weather strip channel portion 43. In a state where the weather strip WS is attached to the weather strip channel portion 43, the lip portion WS2 protrudes towards the vehicle rear side. Because a distal end portion of the lip portion WS2 is in contact with the vehicle body in a case where the vehicle door VD is closed, the gap between the rear column portion 2 and the vehicle body is sealed, and thus foreign materials (including, for example, water drops) are prevented from coming into a vehicle cabin.

The weather strip channel portion 43 includes a bottom wall portion 431, an inner side folded-back portion 432 and an outer side folded-back portion 433. The bottom wall portion 431 extends in the vehicle width direction. The inner side folded-back portion 432 is folded or bent from an end of the bottom wall portion 431, which is at the vehicle inner side, of the bottom wall portion 431 in the vehicle outer direction towards the vehicle rear side. The outer side folded-back portion 433 is folded or bent from an end of the bottom wall portion 431, which is at the vehicle outer side, in the vehicle inner direction towards the vehicle rear side. The support portion WS1 of the weather strip SW is attached inside a space portion surrounded by the bottom wall portion 431, the inner side folded-back portion 432 and the outer side folded-back portion 433. The support portion WS1 includes an inner side leg portion L1 formed to protrude towards the vehicle inner side and an outer side leg portion L2 formed to protrude towards the vehicle outer side. The inner side leg portion L1 is arranged at a space portion between the bottom wall portion 431 and the inner side folded-back portion 432 of the weather strip channel portion 43. The outer side led portion L2 is arranged at a space portion between the bottom wall portion 431 and the outer side folded-back portion 433 of the weather strip channel portion 43. As is clear from FIGS. 3 and 4, the inner side leg portion L1 is arranged at a position that is sandwiched between the bottom wall portion 431 and the inner side folded-back portion 432 and the outer side leg portion L2 is arranged at a position that is sandwiched between the bottom wall portion 431 and the outer side folded-back portion 433 on that the weather strip WS does not come off the weather strip channel portion 43.

Next, a method of manufacturing the rear column portion 2, which includes the above-explained configuration, will be explained.

(Glass run channel forming process) First, a metal plate including an elongated shape is roll-formed and cut in a predetermined length. Thus, the glass run channel portion 5 includes the cross-sectional configuration illustrated in FIGS. 3 and 4.

Next, the main portion 4 is formed. The main portion 4 is formed through a roll process, a press process and a trimming process.

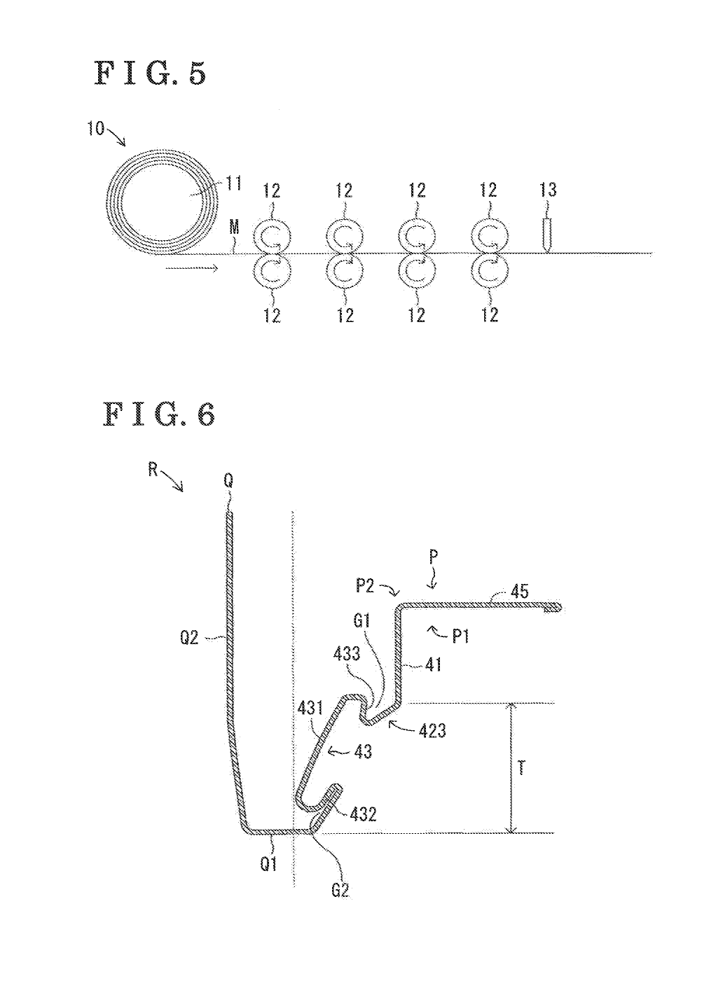

(Roll process) FIG. 5 is a view illustrating a roll forming apparatus for roll-forming the main portion 4. As illustrated in FIG. 5, the roll forming apparatus 10 includes an uncoiler 11, plural pairs of rolling dies 12 and a cutting apparatus 13. A metal steel plate M which includes an elongated shape and is supplied from the uncoiler 11 is plastic-deformed by the plural pairs of rolling dies 12. The plastic-deformed metal steel plate M is out in the predetermined length with the cutting apparatus 13, and accordingly an intermediate formed product formed in the elongated shape and including a constant cross-sectional configuration is formed.

FIG. 6 is a cross-sectional view that is orthogonal to a long-side direction of an intermediate formed product R which is formed through a roll forming process, that is, the roll process. In the a cross-sectional configuration of the intermediate formed product R illustrated in FIG. 6, a configuration of a right half portion (i.e., a restrained portion) P which is positioned at the right side relative to the dotted line is identical to the cross-sectional configuration of the main portion 4 illustrated in FIGS. 3 and 4. Accordingly, the horizontal wall portion 41, the rear wall portion 423 of the recessed portion 42, the weather strip channel portion 43 and the outer wall portion 45, which are included in the main portion 4, are formed in the roll forming process. On the other hand, a left half portion (i.e., an unrestrained portion) Q which is positioned at the left side relative to the dotted line includes a bottom part Q1 and a vertical part Q2. The bottom part Q1 extends in a horizontal direction from a lower end portion of the rear wall portion 423 formed at the right half portion P and the vertical part Q2 extends in the upper direction from a left end of the bottom part Q1 when viewed in FIG. 6.

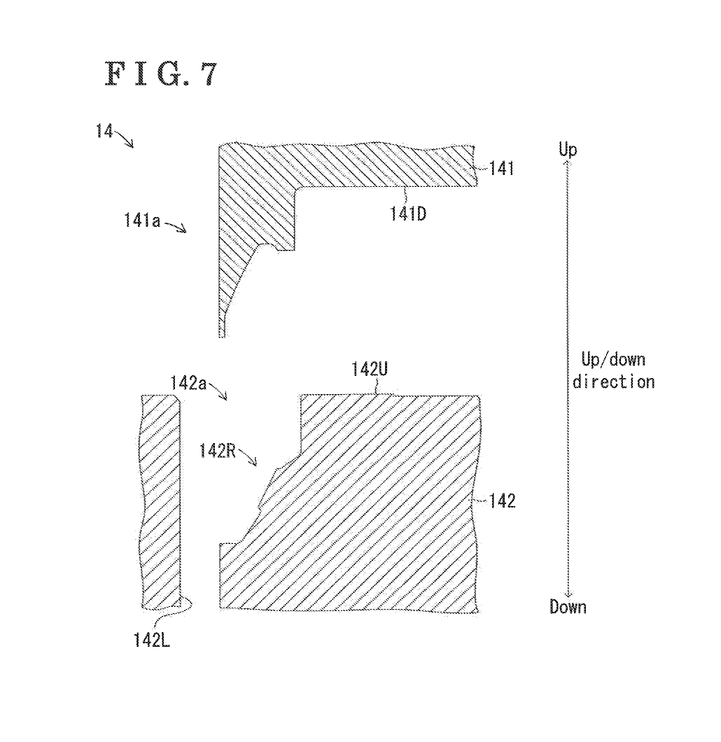

(Press process) Next, the intermediate formed product R is press-formed. FIG. 7 is a cross-sectional view illustrating a die 14 used in the press process. As illustrated in FIG. 7, the die 14 includes an upper die 141 and a lower die 142. Each of the upper die 141 and the lower die 142 is formed in such a manner that a cross-sectional configuration thereof is constant across a depth direction of the paper surface on which FIG. 7 is drawn (that is, in the direction from a front side towards a back side). The lower die 142 includes a concave portion 142a which is formed to pass through the lower die 142 in an up/down direction in FIG. 7. One wall surface (a left wall surface) 142L which forms or defines the concave portion 142a is a flat surface which is parallel to the up/down direction. The other wall surface (a right wall surface) 142R which defines the concave portion 142a is formed so as to include a configuration that is identical to a configuration of a one-side surface P1 of the right half portion P so that the right half portion P of the cross-sectional configuration of the intermediate formed product R, which is illustrated in FIG. 6, is fitted in the concave portion 142a from above. In addition, the upper die 141 includes a bottom surface 141D and a protruding surface 141a. The bottom surface 141D is configured to be joined to an upper surface 142U of the lower die 142. The protruding surface 141a enters the concave portion 142a of the lower die 142 in a case where the upper surface 142U and the bottom surface 141D are joined to each other. The protruding surface 141a is formed to include a configuration that is identical to that of another one-side surface P2 (refer to FIG. 6) of the right half portion P of the intermediate formed product R.

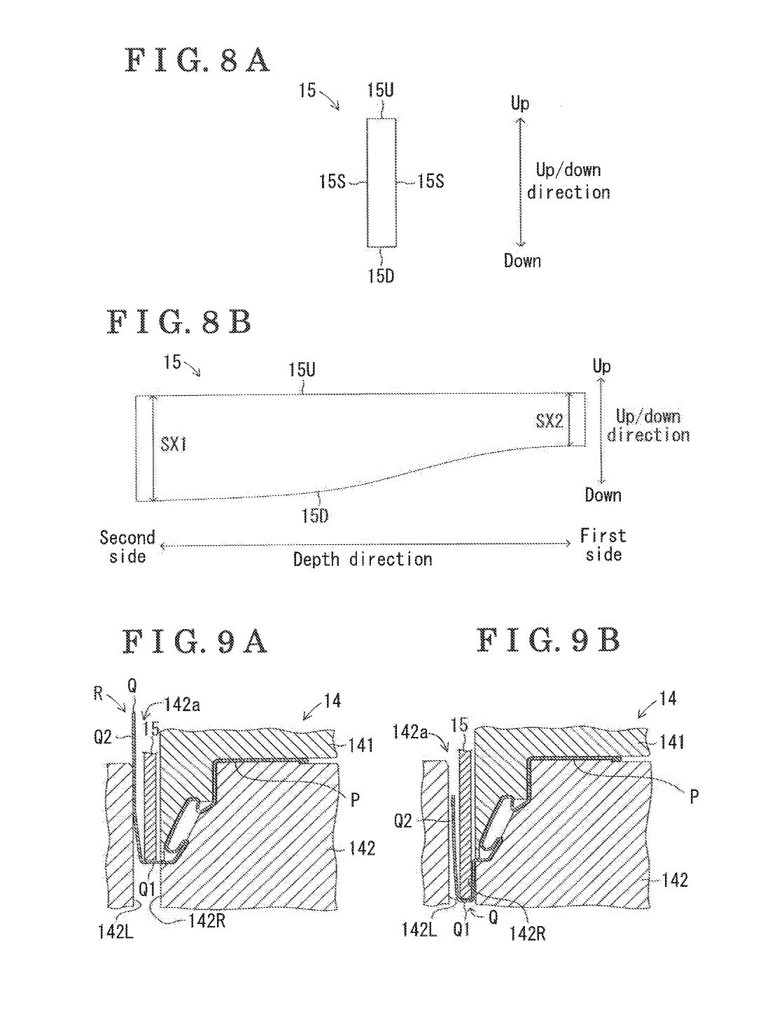

FIG. 8A is a front view schematically illustrating an example of a punch 15 used in the press process and FIG. 8B is a lateral view schematically illustrating the same. The punch 15 includes an upper surface 15U, a bottom surface 15D and lateral surfaces 15S, 15S facing each other. A cross-sectional configuration of the punch 15, which is orthogonal to the depth direction, is a substantially rectangular shape that is elongated in the up/down direction. A length of the punch 15 in the up/down direction continuously changes along the depth direction. As illustrated in FIG. 8B, a length SX1 of the punch 15 in the up/down direction is longest at a left end portion (the end portion at a second side in the depth direction) of the punch 15. The length of the punch 15 in the up/down direction becomes gradually and continuously reduced from the left end portion towards a right-hand side (a first side in the depth direction). A length SX2 of the punch 15 in the up/down direction is shortest at a right end portion (the end portion at the first side in the depth direction) of the punch 15. The upper surface 15U is arranged to be horizontal relative to the depth direction and the bottom surface 15D is arranged to be inclined relative to the depth direction. Accordingly, a position of the bottom surface 15D in the up/down direction is lowest at the end portion of the punch 15 at the second side in the depth direction and the position of the bottom surface 15D in the up/down direction is highest at the end portion of the punch 15 at the first side in the depth direction. Between the end portion at the first side and the end portion at the second side in the depth direction, the position of the bottom surface 15D in the up/down direction becomes higher from the second side towards the first side in the depth direction of the punch 15.

In a case where the intermediate formed product R is press-formed, first, the intermediate formed product R is set at the lower die 142. At this time, the intermediate formed product R is fixed at the lower die 142 by fitting the right half portion P, which includes the weather strip channel portion 43, of the intermediate formed product R at the right wall surface 142R of the concave portion 142a of the lower die 142. After the intermediate formed product R is fixed at the lower die 142, the upper die 141 is joined to or mated with the lower die 142 so that the bottom surface 141D of the upper die 141 and the upper surface 142U of the lower die 142 face each other. Accordingly, the right half portion P of the intermediate formed product R is sandwiched by the upper die 141 and the lower die 142, and restrained thereat. Next, in a state where the right half portion P, which includes the weather strip channel portion 43, is restrained by the upper die 141 and the lower die 142, the punch 15 is pushed into or fitted into the concave portion 142a of the die 14 from above downwardly. The left half portion Q (the unrestrained portion) of the intermediate formed product R is press-formed by the pushing operation of the punch 15.

Each of FIGS. 9A and 9B is a view indicating a state of deformation of the intermediate formed product R which is press-formed in the press process. FIG. 9A illustrates a positional relation between the intermediate formed product R and the punch 15 in the die 14 immediately before the intermediate formed product R is press-formed. FIG. 9B illustrates a positional relation between the intermediate formed product R and the punch 15 in the die 14 immediately after the intermediate formed product R is press-formed. Each of FIGS. 9A and 9B indicates the positional relation between a vicinity of the end portion of the punch 15 at the second side in the depth direction, that is, the portion at which the length of the punch 15 in the up/down direction is longest, and the intermediate formed product R.

As illustrated in FIG. 9A, the right half portion P of the intermediate formed product R is disposed between the upper die 141 and the lower die 142, and thus restrained therebetween. The left half portion Q of the intermediate formed portion R is in a free state. That is, the right half portion P of the intermediate formed product R serves as the restrained portion which is restrained by the die 14 and the left half portion D of the intermediate formed product R serves as the unrestrained portion which is not restrained by the die 14. In this fixed state, the bottom part Q1 of the left half portion Q is arranged so as to extend across the concave portion 142a and the vertical part Q2 is arranged so as to match or follow the left wall surface 142L of the concave portion 142a.

After the intermediate formed product R is set at the die 14, the punch 15 is pushed into the concave portion 142a of the lower die 142. Then, as illustrated in FIG. 9B, the unrestrained portion (the left half portion Q of the intermediate formed product R) is plastic-deformed by the punch 15. At this time, as the punch 15 moves in the lower direction, the bottom part Q1 of the left half portion Q is pressed by the punch 15 and by the lower die 142, and is plastic-deformed so as to follow the right wall surface 142R of the lower die 142. In addition, the vertical part Q2 of the left half portion is pulled into or drawn into the concave portion 142a. Consequently, the left half portion Q is plastic-deformed so as to be recessed in the lower direction in FIG. 9B. Thus, the bottom portion 421 of the recessed portion 42 is formed by means of the above-described plastic deformation.

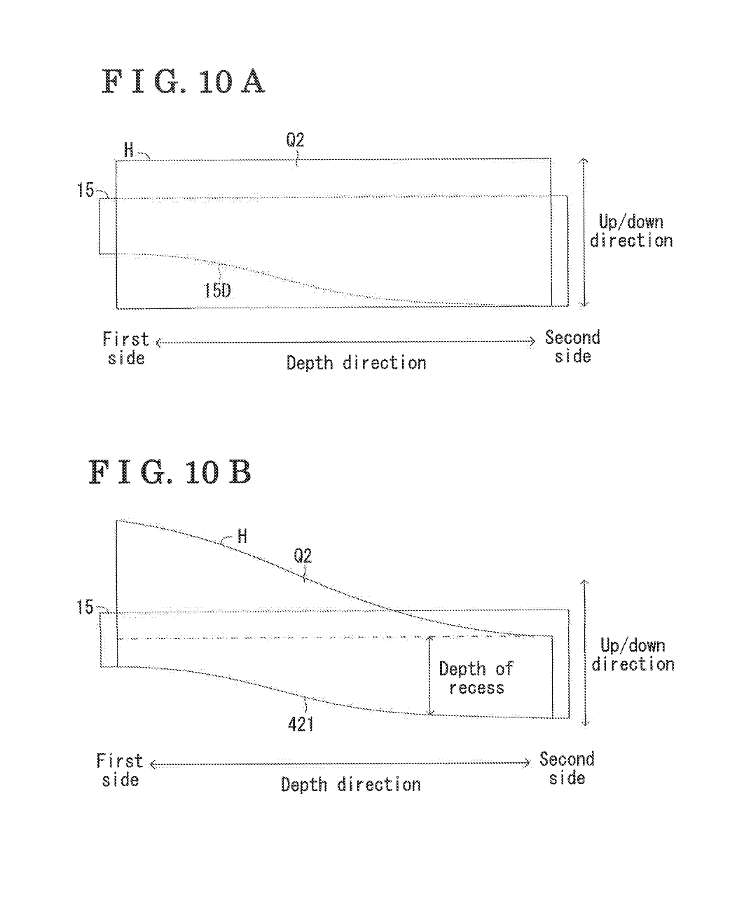

FIGS. 10A and 10B are views respectively illustrating the positional relations between the punch 15 and the intermediate formed product R before and after the press forming, which are viewed from a lateral direction. FIG. 10A illustrates the positional relations between the punch 15 and the intermediate formed product R immediately before the press forming, and FIG. 10B illustrates the positional relations between the punch 15 and the intermediate formed product R immediately after the press forming. As explained above, the position of the bottom surface 15D of the punch 15 in the up/down direction changes along the depth direction. Therefore, in a vicinity of the end portion of the punch 15 at the second side in the depth direction, an amount of the vertical part Q2 of the left half portion Q of the intermediate formed product R, which is pulled into the concave portion 142a of the die 14 during the press forming, is large, and thus, the depth of the recess that is formed at the unrestrained portion during the press forming is large. On the other hand, in a vicinity of the end portion of the punch 15 at the first side in the depth direction, the amount of the vertical part Q2 of the left half portion Q of the intermediate formed product R, which is pulled into the concave portion 142a during the press forming, is small, and thus, the depth of the recess that is formed at the unrestrained portion during the press forming is small.

In addition, as explained above, the amount of the vertical part Q2 which is pulled into the concave portion 142a at the press forming differs along the depth direction. Consequently, as illustrated in FIG. 10A, an upper end position of the vertical part Q2 of the left half portion Q of the intermediate formed product R, that is, a height position H of an end edge of the unrestrained portion in the up/down direction, is constant or uniform along the depth direction (the long-side direction) before the press forming. On the other hand, as illustrated in FIG. 10B, the height position H changes along the depth direction (the long-side direction) after the press forming. A pull-in speed at which the punch 15 pulls the vertical part Q2 is approximately twice a lowering speed of the punch 15, and therefore, along the depth direction, an amount of change in the upper end position H of the vertical part Q2 is larger than an amount of change in a depth of a recess.

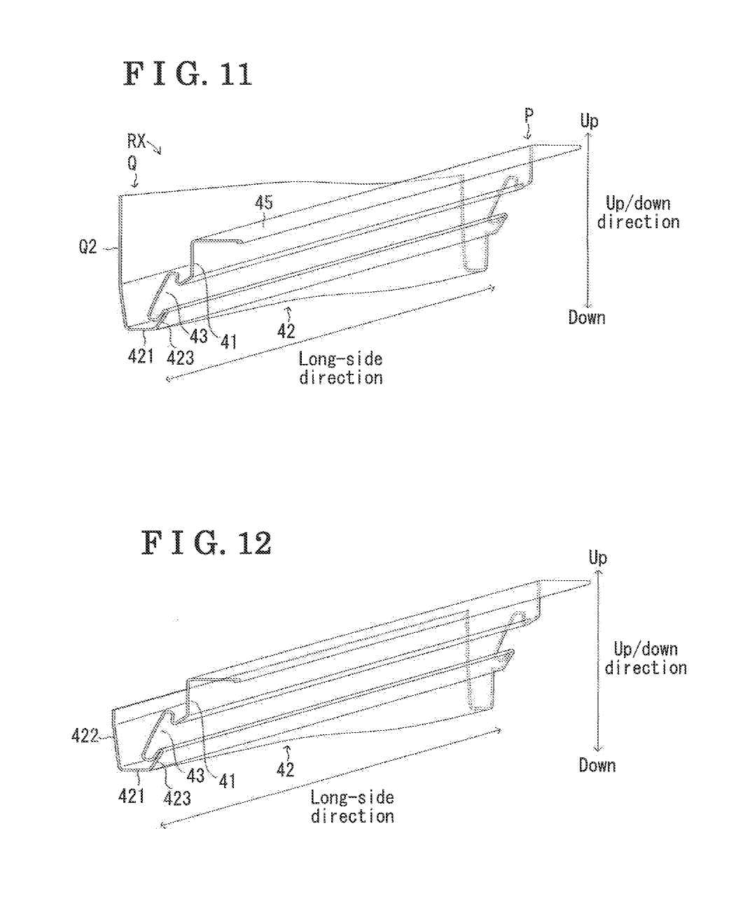

FIG. 11 is a perspective view of an intermediate formed product RX which has undergone the press process. The intermediate formed product RX includes an elongated shape. End portions of the intermediate formed product RX in the long-side direction, and an upper portion of the intermediate formed product RX when viewed in FIG. 11 are opened. The horizontal wall portion 41, the rear wall portion 423, the weather strip channel portion 43 and the outer wall portion 45 of the main portion 4 are formed at the restrained portion (the right half portion P) of the intermediate formed product RX. In addition, because the unrestrained portion (the left half portion Q) of the intermediate formed product RX is pressed by the punch 15 in the press process, the recessed portion 42 (the bottom portion 421) is formed at the unrestrained portion (the left half portion Q). The recessed portion 42 is recessed in the direction that is orthogonal to the long-side direction of the intermediate formed product RX and the recessed portion 42 includes a portion at which the depth of the recess is changed along the long-side direction so that the depth of the recess becomes continuously deeper, that is, the depth of the recess continuously increases from the first side to the second side in the long-side direction.

(Trimming process) As is clear from FIG. 11, the height position of an upper end edge of the vertical part Q2 of the left half portion Q of the intermediate formed product RX in the up/down direction, that is, the height position of the end edge of the unrestrained portion in the up/down direction, changes or varies along the long-side direction. In the trimming process, the unrestrained portion is cut off, that is, trimmed over the long-side direction so that the height position of the end edge of the unrestrained portion in the up/down direction is constant along the long-side direction. FIG. 12 is a perspective view of a formed product which has undergone the trimming process. The front wall portion 422 of the recessed portion 42 of the main portion 4 is formed through the trimming process. Accordingly, the main portion 4, which is made of one piece of metal plate so as to be formed in the elongated configuration, is completed.

(Assembly process) Next, the glass run channel portion 5 and the main portion 4 are assembled on each other. In this case, the glass run channel portion 5 and the main portion 4 are assembled on each other so that the respective long-side directions thereof coincide to each other. In addition, as illustrated in FIGS. 3 and 4, the glass run channel portion 5 and the main portion 4 are assembled on each other so that the inner wall portion 53 of the glass run channel portion 5 covers an opening of the recessed portion 42 of the main portion 4.

(Joining process) Next, a contact portion, at which a distal end portion of the front wall portion 422 of the recessed portion 42 (that is, an opening edge of the recessed portion 42) of the main portion 4 and a distal end portion (a front end portion in the vehicle front/rear direction) of the inner wall portion 53 of the glass run channel portion 5 are in contact with each other, is joined by projection welding. Thus, the glass run channel portion 5 is firmly fixed to the main portion 4. After this, by bending and curving the glass run channel portion 5 and the main portion 4, which are fixed firmly to each other, in the direction indicated in FIG. 2 by using, for example, a roll bender, the rear column portion 2 is formed. The rear column portion 2 is arranged at a rear end portion of the upper surface of the door panel DP in the vehicle front/rear direction in a manner that a side of the recessed portion 42 at which depth of the recess of the recessed portion 42 is deep is arranged downward and that a side of the recessed portion 42 at which the depth of the recess is shallow is arranged upward. Then, the rear column portion 2 is mounted on the door panel DP. Further, the front column portion 1 is mounted on the door panel DP, and the upper end the front column portion and the upper end of the rear column portion 2 are connected with the upper portion connecting portion 3. Thus, the door sash DS for the vehicle is mounted on the door panel DP.

As explained above, the rear column portion 2 of the door sash DS for the vehicle according to this embodiment includes the main portion 4 which is made of a piece of metal plate and is formed in the elongated configuration, and the main portion 4 includes the recessed portion 42 which is recessed in the vehicle width direction and is formed along the long-side direction of the main portion 4. The rear column portion 2 includes the glass run channel portion 5 which is made of a piece of metal plate and is formed in the elongated configuration, the glass run channel portion 5 is assembled on the main portion 4 in a manner that the long-side direction of the glass run channel portion 5 coincides with the long-side direction of the main portion 4, the glass run channel portion 5 includes the inner wall portion 53 covering the opening surface of the recessed portion 42, and the glass run channel portion 5 is configured to be mounted with the glass run for guiding the movement of the door glass DG which is movably attached to the door panel DP. In addition, the recessed portion 42 is configured so that the depth of the recess of the recessed portion 42 is reduced from the portion thereof which is positioned at the upper surface of the door panel DP towards the upper direction. The weather strip channel portion 43 is formed at the main portion 4, and the weather strip WS for sealing the gap between the body of the vehicle and the rear column portion 2 is configured to be attached to the weather strip channel portion 43. In addition, the recessed portion 42 is configured to include the bottom portion 421 positioned at the vehicle inner side and including the surface that is orthogonal to the vehicle width direction, the front wall portion 422 extending from the front end of the bottom portion 421 in the vehicle front/rear direction towards the vehicle outer side and the rear wall portion 423 extending from the rear and of the bottom portion 421 in the vehicle front/rear direction towards the vehicle outer side.

According to this embodiment, because the weather strip channel portion 43 is formed or provided at the main portion 4, the column portion of the door sash DS for the vehicle may be manufactured with a less number of metal plates compared to a case where the weather strip channel portion is made of a separate metal plate. Consequently, material costs may be reduced and an assembling workload may be reduced. In addition, a seal member for sealing the weather strip channel portion is not needed, and therefore the costs and the workload may be reduced even more.

In addition, the weather strip channel portion 43 provided at the main portion 4 is formed by roll-forming a piece of metal plate, and the recessed portion 42 provided at the main portion 4 is formed by press-forming the left half portion Q (the unrestrained portion), which is not restrained, in a state where the weather strip channel portion 43 of the intermediate form product R, at which the weather strip channel portion 43 is formed, is restrained at the die 14 so that the depth of the recess is reduced from the portion thereof which is positioned at the upper surface of the door panel DP towards the upper direction. Consequently, the door sash DS for the vehicle, which includes the rear column portion 2 having a high accuracy, is formed.

The method for manufacturing the door sash DS for the vehicle (or the method for manufacturing the rear column portion 2 extending in the elongated configuration from the upper surface of the door panel DP of the vehicle towards the upper direction) according to this embodiment includes the roll process for forming the intermediate formed product R by roll-forming the metal plate including the elongated shape, the intermediate formed product R being formed in the elongated shape and including the constant cross-sectional configuration at which the weather strip channel portion 43 is formed, the weather strip WS for sealing the gap between the body of the vehicle and the rear column portion 2 being attached to the weather strip channel portion 43, and the press process for forming the recessed portion 42 (the bottom portion 421) at the intermediate formed product R, the recessed portion 42 being recessed in the direction that is orthogonal to the long-side direction of the intermediate formed product R and including the portion at which the depth of the recess changes along the long-side direction in a manner that the depth of the recess continuously increases from the first side to the second side in the long-side direction, wherein the left half portion Q (the unrestrained portion) which is not restrained is pressed by the punch 15 while the right half portion P (the restrained portion) including the weather strip channel portion 43, which is formed at the intermediate formed product R, is restrained by the die 14. In addition, the method for manufacturing the door sash DS for the vehicle according to this embodiment further includes the trimming process for forming the main portion 4 by trimming the left half portion Q so that the end edge of the left half portion Q along the long-side direction of the intermediate formed product RX is horizontal relative to the long-side direction of the intermediate formed product RX, the trimming process is conducted after the press process is conducted.

According to the manufacturing method of the door sash DS for the vehicle (or the manufacturing method of the column portion) related to this embodiment, the main portion 4 of the rear column portion 2 is formed through the roll process, the press process and the trimming process. The weather strip channel portion 43 is formed in the roll process, the recessed portion 42 whose depth continuously changes along the long-side direction is formed in the press process. Because the weather strip channel portion 43 is restrained by the die 14 in the press process, the weather strip channel portion 43 is prevented from deforming in a case where the unrestrained portion (the left half portion Q of the intermediate formed product) is pushed or pressed by the punch 15. Consequently, the door sash DS (or the column portion) for the vehicle, which includes the rear column portion 2 having the high accuracy, is formed.

According to the method for manufacturing the door sash DS for the vehicle (or the manufacturing method of the column portion) includes the glass run channel forming process for forming the glass run channel portion 5 by roll-forming the metal plate formed in the elongated shape, the glass run channel portion 5 being mounted with the glass run for guiding the movement of the door glass DG which is movably attached to the door panel DP, the assembly process for assembling the main portion 4 and the glass run channel portion 5 on each other so that the opening surface of the recessed portion 42 is covered with the inner wall portion 53 of the glass run channel portion 5, and the joining process for joining the opening edge of the recessed portion 42 (a distal end edge of the front wall portion 422) of the main portion 4 and the distal end portion of the inner wall portion 53 of the glass run channel portion 5 by projection welding, the main portion 4 and the glass run channel portion 5 being assembled on each other in the assembly process. According to this manufacturing method, the rear column portion 2 of the door sash DS for the vehicle is formed or made of two pieces of metal plate, and accordingly the material costs may be reduced and the assembling workload may be reduced compared to a known column portion where three pieces of metal plate are used. In addition, because the main portion 4 and the glass run channel portion 5 are joined to each other by means of the projection welding, the main portion 4 and the glass run channel portion 5 are joined to each other tightly.

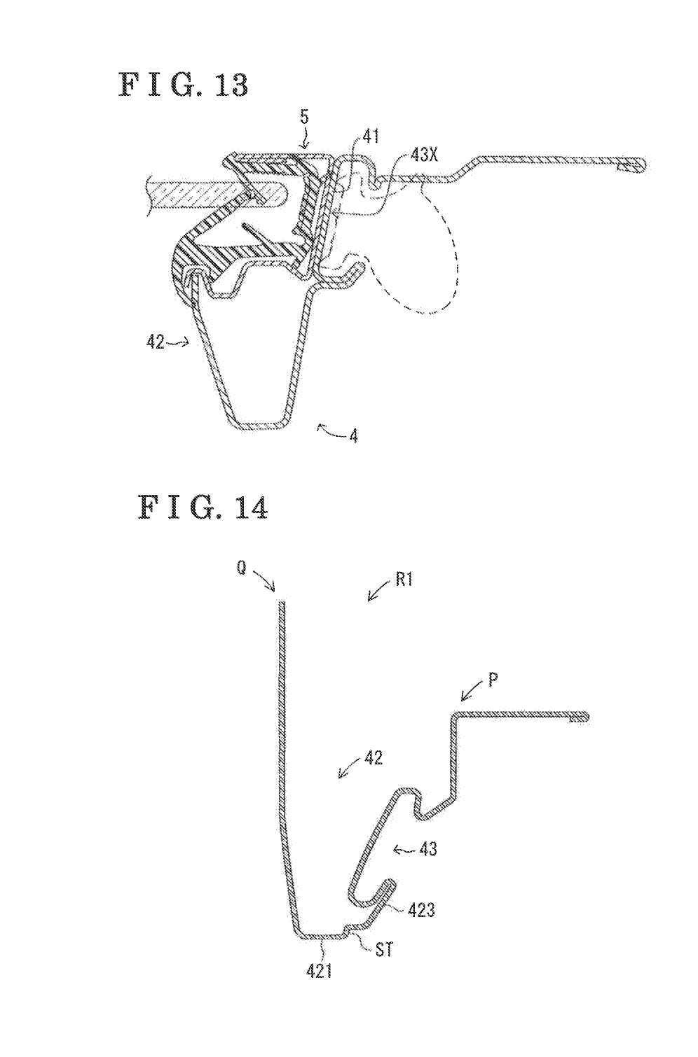

The disclosure is not limited to the aforementioned embodiment. For example, the weather strip channel portion 43 is formed at the recessed portion 42 of the main portion 4 according to the example described in the aforementioned embodiment, however, the weather strip channel portion may be formed at a portion other than the recessed portion 42. For example, as illustrated in FIG. 13, a weather strip channel portion 43X may be formed at the horizontal wall portion 41 of the main portion 4. In this case, in a state where the horizontal wall portion 41 and the weather strip channel portion 43X are restrained at the die in the press process, the unrestrained portion that is not restrained is pressed by the punch, and thus the recessed portion 42 whose depth changes or varies in the long-side direction is formed.

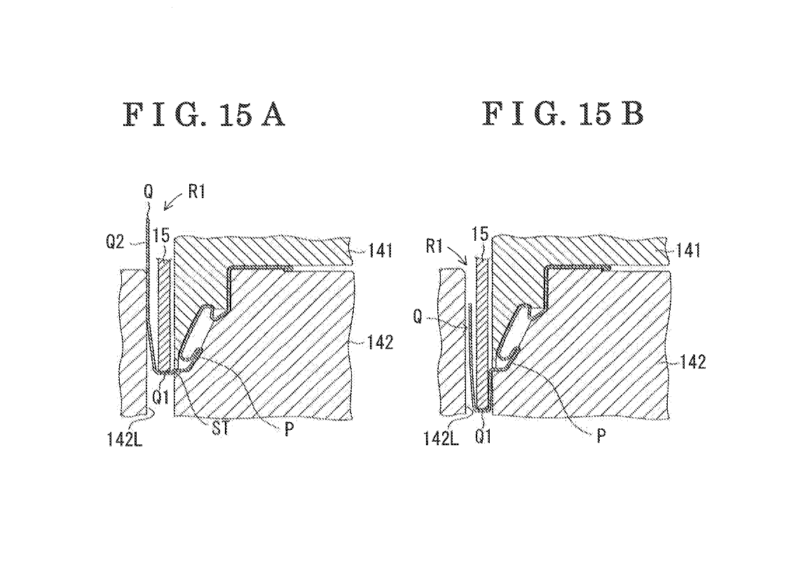

In addition, instead of the intermediate formed product R which is illustrated in FIG. 6, an intermediate formed product R1 which is illustrated in FIG. 14 may be formed in the roll process. A step ST is formed at the intermediate formed product R1, at a boundary portion between the unrestrained portion Q that is pressed by the punch in the subsequent press process and the restrained portion P that is not pressed by the punch. The step ST is provided along a direction in which the unrestrained portion Q is pressed by the punch (in a pressing direction of the punch) in the subsequent press process. The restrained portion P and the unrestrained portion Q are distinguished or differentiated from each other by the step ST. In the press process, a distal end of the punch 15 is arranged along the step ST as illustrated in FIG. 15A. In this state, the punch 15 presses the unrestrained portion Q as illustrated in FIG. 15B. Accordingly, a pressing force which is applied by the punch 15 and works at the restrained portion P may be reduced by the presence of the step ST. That is, a starting point or an origin of a portion which is to be bent or folded by the punch 15 is defined beforehand by the step ST. Therefore, a pull-in force which is applied by the punch 15 and works at the restrained portion P is smaller compared to a case where the unrestrained portion is bent or folded by the punch 15 for the first time. Consequently, it is effectively prevented that the material is pulled from the restrained portion P into the concave portion 142a in association with the movement of the punch 15. Thus, the restrained portion P, specifically, the weather strip channel portion 43, is prevented from deforming in the press process. As a result, the rear column portion 2 including the high accuracy may be formed. In a case where the intermediate formed product R1 is eventually formed as the main portion 4 of the rear column portion 2 and then is mounted on the vehicle, the step ST is provided along the vehicle width direction from the bottom portion 421 of the recessed portion 42 to the rear wall portion 423 of the recessed portion 42 as illustrated in FIG. 14.

Further, in the press process, an upper end edge of the unrestrained portion Q of the intermediate formed product R may be pushed into the concave portion 142a in a direction that is identical to the pressing direction of the punch 15, in addition to that the punch 15 presses the unrestrained portion Q of the intermediate formed product R. By pushing or pressing the unrestrained portion Q positively or actively during the press forming, the unrestrained portion Q is easily pulled in by the punch 15. As a result, it is prevented or reduced even more reliably that the material is pulled into the concave portion 142a from the restrained portion P. Consequently, the restrained portion P, specifically, the weather strip channel portion 43, is prevented from deforming in the press process, and therefore the door sash DS for the vehicle (the rear column portion) may be formed with even higher accuracy.

In addition, at the intermediate formed product R that is formed in the roll process of the aforementioned embodiment, as illustrated in FIG. 6, a gap G1 between the outer side folded-back portion 433 of the weather strip channel portion 43, and the rear wall portion 423 is relatively large, however, a gap G2 between the inner side folded-back portion 432, and the rear wall portion 423 is extremely small. That is, from among end portions of the weather strip channel portion 43, the end portion which is closer to the unrestrained portion is folded back, and the roll forming is performed so that the gap of the folded-back portion (the gap G2) is crushed. By performing the roll-forming work so that the gap G2 is extremely narrow or small (specifically, the gap G2 is 0.2 mm or less, for example), there is a low probability that the material which constitutes the restrained portion is pulled into the concave portion 142a in association with the action of the punch 15 during the press process. Consequently, the deformation of the weather strip channel portion 43 may be prevented or reduced even more.

Each of the aforementioned feature that the step ST is formed in the roll process, the aforementioned feature that the gap G2 is formed no as to be extremely small in the roll process, and the aforementioned feature that the end edge of the unrestrained portion is positively pushed in the direction that is identical to the pressing direction of the punch 15 in the press process, is an example of a means or mechanism which prevents the restrained portion from being pulled in by the punch 15 in the press process (that is, a restraint portion pull-in prevention means or mechanism). In a case where one or more of the restraint portion pull-in prevention means is employed, the door sash DS for the vehicle (the rear column portion) including even higher accuracy may be formed.

The structure of the rear column portion 2 of the door sash DS for the vehicle and the manufacturing method thereof are described in the aforementioned embodiment, however, the aforementioned embodiment may be used for the front column portion 1. Thus, the embodiment disclosed here may be changed or modified without departing from the principle and scope thereof.

According to the aforementioned embodiment, the door sash DS for the vehicle includes the rear column portion 2 extending in the elongated configuration from the upper surface of the door panel DP of the vehicle towards the upper direction, wherein the rear column portion 2 includes the main portion 4 which is made of a piece of metal plate and is formed in the elongated configuration, the main portion 4 including the recessed portion 42 which is recessed in the vehicle width direction and is formed in the long-side direction of the main portion 4, the rear column portion 2 includes the glass run channel portion 5 which is made of a piece of metal plate and is formed in the elongated configuration, the glass run channel portion 5 being assembled on the main portion 4 in a manner that the long-side direction of the glass run channel portion 5 coincides with the long-side direction of the main portion 4, the glass run channel portion 5 including the inner wall portion 53 covering the opening surface of the recessed portion 42, the glass run channel portion 5 being configured to be mounted with the glass run for guiding the movement of the door glass DG which is movably attached to the door panel DP, the recessed portion 42 is configured so that the depth of the recess of the recessed portion 42 is reduced from the portion thereof which is positioned at the upper surface of the door panel DP towards the upper direction, and the weather strip channel portion 43 is formed at the main portion 4, and the weather strip WS for sealing the gap between the body of the vehicle and the rear column portion 2 is configured to be attached to the weather strip channel portion 43.

According to the above-described configuration, the rear column portion 2 of the door sash DS for the vehicle includes the main portion 4 which is made of a piece of metal plate and is formed in the elongated configuration, and the glass run channel portion 5 which is made of a piece of metal plate and is formed in the elongated configuration. The recessed portion 42 recessed in the vehicle width direction is formed at the main portion 4. The opening surface of the recessed portion 42 is covered with the inner wall portion 53 of the glass run channel portion 5. Thus, the closed cross section is formed. In addition, the weather strip channel portion 43 is formed at the main portion 4. Accordingly, the rear column portion 2 of the door sash DS may be manufactured with a less number of metal plates compared to the case where the weather strip channel portion is made of a separate metal plate. Consequently, the material costs and the assembling workload may be reduced. In addition, the seal member for sealing the weather strip channel portion 43 is not needed because the weather strip channel portion 43 is provided at the main portion 4 so as to be integral therewith. Therefore the costs and the workload may be reduced even more.

According to the aforementioned embodiment, the weather strip channel portion 43 is formed by roll-forming a piece of metal plate, and the recessed portion 42 is formed by press-forming the left half portion Q, which is not restrained, in a state where the weather strip channel portion 43 of the metal plate at which the weather strip channel portion 43 is formed is restrained at the die 14 so that the depth of the recess of the recessed portion 42 is reduced from the portion thereof which is positioned at the upper surface of the door panel DP towards the upper direction.

In order to enhance a holding force for holding the weather strip WS, the weather strip channel portion 43 formed at the door sash DS for the vehicle is often formed as the recessed part. Specifically, the recessed part includes the configuration where the inner side leg portion L1 is arranged at the position that is sandwiched between the bottom wall portion 431 and the inner side folded-back portion 432 and the outer side leg portion L2 is arranged at the position that is sandwiched between the bottom wall portion 431 and the outer side folded-back portion 433 so that the weather strip WS does not come off the weather strip channel portion 43. The configuration of the recessed part may not be formed by the press forming, however, the configuration of the recessed part may be formed by the roll forming. In addition, the portion which includes the cross-sectional configuration with the gradual change where the depth of the recess is gradually changed, like the recessed portion 42 of this embodiment, may not be formed by the roll forming, however, may be formed by the press forming. According to the aforementioned embodiment, the weather strip channel portion 43 is formed by roll forming and the cross-sectional configuration of the recessed portion 42 where the depth of the recess is gradually changed is formed by press forming. Thus, the door sash DS for the vehicle, which includes the rear column portion 2 having the high accuracy, is provided. Further, the weather strip channel portion 43 is restrained by the die 14 when the recessed portion 42 is being press-formed, and thus the deformation of the weather strip channel portion 43 during the press-forming is prevented or reduced. Consequently, the door sash DS for the vehicle, which is provided with the rear column portion 2 including less deformation and high accuracy, is provided.

According to the aforementioned embodiment, the recessed portion 42 includes the bottom portion 421 positioned at the vehicle inner side and including the surface that is orthogonal to the vehicle width direction, the front wall portion 422 extending from the front end of the bottom portion 421 in the vehicle front/rear direction towards the vehicle outer side and the rear wall portion 423 extending from the rear end of the bottom portion 421 in the vehicle front/rear direction towards the vehicle outer side.

According to the above-described configuration, the rigidity of the rear column portion 2 is enhanced.

According to the aforementioned embodiment, the recessed portion 42 includes the step ST formed in the vehicle width direction, and provided between the bottom portion 421 and the rear wall portion 423, and the recessed portion 42 is formed by restraining the rear wall portion 423 and by press-forming the bottom portion 421, the press-forming being started from the step ST which is used as the starting point of bending.

Here, “the step ST formed in the vehicle width direction” refers to the step that has a step surface including two surfaces which are formed at different positions from each other along the vehicle width direction, and which are orthogonal to the vehicle width direction. According to this configuration, the step portion is used as the starting point of the bending work performed in the press process in a case where the recessed portion 42 is press-formed. For example, the distal end of the punch 15 may be arranged so as to follow the step ST. Then, the step portion may be used as the starting point of the press forming, and the press forming is performed so that the step portion, which is already bent beforehand, is further bent or folded. Accordingly, less pressing force is needed in the press forming, and thus the pressing force that is transmitted to the weather strip channel portion 43, which is restrained in the press forming, is reduced. As a result, the weather strip channel portion 43 restrained during the press forming is prevented, as much as possible, from being pulled in the movement of the punch 15 due to the pressing force during the press forming, and thus the deformation of the weather strip channel portion 43 may be minimized.

According to the aforementioned embodiment, the opening edge of the recessed portion 42 is joined to the inner wall portion 53 of by the projection welding.

According to the above-described configuration, the opening edge of the recessed portion 42 of the main portion 4 and the inner wall portion 53 of the glass run channel portion 5 are joined to each other by the projection welding, and thus the main portion 4 and the glass run channel portion 5 are joined to each other firmly and tightly.

According to the aforementioned embodiment, the method for manufacturing the door sash DS for the vehicle, the door sash DS configured to include the rear column portion 2 extending in the elongated configuration from the upper surface of the door panel DP of the vehicle towards the upper direction, the rear column portion 2 including the main portion 4 which is made of a piece of metal plate and is formed in the elongated configuration, the main portion 4 including the recessed portion 42 which is recessed in the vehicle width direction and is provided in the long-side direction of the main portion 4, the rear column portion 2 including the glass run channel portion 5 which is made of a piece of metal plate and is formed in the elongated configuration, the glass run channel portion 5 being assembled on the main portion 4 in a manner that the long-side direction of the glass run channel portion 5 coincides with the long-side direction of the main portion 4, the glass run channel portion 5 including the inner wall portion 53 covering the opening surface of the recessed portion 42, the glass run channel portion 5 being configured to be mounted with the glass run for guiding the movement of the door glass DG which is movably attached to the door panel DP, the method for manufacturing the door sash DS for the vehicle includes the roll process for forming the intermediate formed product R, R1 by roll-forming the metal plate including the elongated shape, the intermediate formed product R, R1 being formed in the elongated shape and including the constant cross-sectional configuration at which the weather strip channel portion 43 is formed, the weather strip WS for sealing the gap between the body of the vehicle and the rear column portion 2 being attached to the weather strip channel portion 43, and the press process for forming the recessed portion 42 at the left half portion Q which is not restrained, the recessed portion 42 being recessed in the direction that is orthogonal to the long-side direction of the intermediate formed product R, R1 and including the portion at which the depth of the recess is continuously changed in the long-side direction, wherein the left half portion Q which is not restrained is pressed by the punch 15 while the right half portion P including the weather strip channel portion 43 formed at the intermediate formed product R, R1 is restrained by the die 14 in the press process.

According to the above-described manufacturing method, the main portion 4 of the rear column portion 2 is formed through the roll process and the press process. The weather strip channel portion 43 is roll-formed in the roll process, and the recessed portion 42, of which depth continuously increases along the long-side direction, is formed in the press process. Because the weather strip channel portion 43 is restrained by the die 14 during the press process, the weather strip channel portion 43 is prevented from deforming in a case where the left half portion Q is pressed by the punch 15. Thus, the door sash DS for the vehicle, which includes the rear column portion 2 having less deformation and high accuracy, is provided.

According to the aforementioned embodiment, the recessed portion 42 is formed in the press process so as to include the portion at which the depth of the recessed portion 42 continuously increases from the first side to the second side in the long-side direction of the intermediate formed product R, R1.

According to the aforementioned embodiment, the method for manufacturing the door sash DS for the vehicle further includes the trimming process for forming the main portion 4 by trimming the left half portion Q so that the end edge of the left half portion Q along the long-side direction of the intermediate formed product RX is horizontal relative to the long-side direction of the intermediate formed product RX, the trimming process being conducted after the press process is conducted.

According to the aforementioned embodiment, the step ST is formed in the roll process, the step ST is formed in the pressing direction of the punch 15 and is provided at the boundary portion between the left half portion Q which is pressed by the punch 15 in the press process and the right half portion P which is not pressed by the punch 15 in the press process, the press process being conducted after the roll process is conducted.

According to the above-described configuration, the step portion is used as the starting point of the bending work performed in the press process in a case where the recessed portion 42 is press-formed. For example, the distal end of the punch 15 may be arranged an as to follow the step ST. Then, the step portion may be used as the starting point of the press forming, and the press forming is performed so that the step portion, which is already bent beforehand, is further bent or folded. Accordingly, less pressing force is needed for the press forming, and thus the pressing force that is transmitted to the weather strip channel portion 43 which is restrained in the press forming, is reduced. As a result, the weather strip channel portion 43 restrained during the press forming is prevented, as much as possible, from being pulled in the movement of the punch 15 due to the pressing force during the press forming, and thus the deformation of the weather strip channel portion 43 may be minimized. Here, “the step ST formed in the pressing direction” refers to the step that has a step surface including two surfaces which are formed at different positions from each other along the pressing direction of the punch 15, and which are orthogonal to the pressing direction of the punch 15.

According to the aforementioned embodiment, the method for manufacturing the door sash DS for the vehicle further includes the glass run channel forming process for forming the glass run channel portion 5 by roll-forming the metal plate formed in the elongated shape, the glass run channel portion 5 being mounted with the glass run for guiding the movement of the door glass DG which is movably attached to the door panel DP, the assembly process for assembling the main portion 4 and the glass run channel portion 5 on each other so that the opening surface of the recessed portion 42 is covered with the glass run channel portion 5, and the joining process for joining the opening edge of the recessed portion 42 of the main portion 4 and the glass run channel portion 5 by projection welding, the main portion 4 and the glass run channel portion 5 being assembled on each other in the assembly process.

According to the above-described configuration, the rear column portion 2 of the door sash DS for the vehicle is formed or made of two pieces of metal plate, and accordingly the material costs may be reduced and the assembling workload may be reduced compared to a known column portion where three pieces of metal plate are used. In addition, the weather strip channel portion 43 is provided at the main portion 4 to be integral therewith, a seal process for sealing the weather strip WS may be omitted. Accordingly, the assembling workload may be further reduced. In addition, because the main portion 4 and the glass run channel portion 5 are joined to each other by the projection welding, the main portion 4 and the glass run channel portion 5 are joined to each other tightly.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A door sash for a vehicle, comprising:
a column portion extending in an elongated configuration from an upper surface of a door panel of the vehicle towards an upper direction, wherein
the column portion includes a main portion which is made of a piece of metal plate and is formed in an elongated configuration, the main portion including a recessed portion which is recessed in a vehicle width direction and is formed in a long-side direction of the main portion,
the column portion includes a glass run channel portion which is made of a piece of metal plate and is formed in an elongated configuration, the glass run channel portion being assembled on the main portion in a manner that a long-side direction of the glass run channel portion coincides with the long-side direction of the main portion, the glass run channel portion including a cover portion covering an opening surface of the recessed portion, the glass run channel portion being configured to be mounted with a glass run for guiding movement of a door glass which is movably attached to the door panel,
the recessed portion is configured so that a depth of a recess of the recessed portion is reduced from a portion thereof which is positioned at the upper surface of the door panel towards the upper direction, and
a weather strip channel portion is formed at the main portion, and a weather strip for sealing a gap between a body of the vehicle and the column portion is configured to be attached to the weather strip channel portion.

2. The door sash for the vehicle according to claim 1, wherein
the weather strip channel portion is formed by roll-forming a piece of metal plate, and
the recessed portion is formed by press-forming an unrestrained portion, which is not restrained, in a state where the weather strip channel portion of the metal plate at which the weather strip channel portion is formed is restrained at a die so that the depth of the recess of the recessed portion is reduced from the portion thereof which is positioned at the upper surface of the door panel towards the upper direction.

3. The door sash for the vehicle according to claim 1, wherein the recessed portion includes a bottom portion positioned at a vehicle inner side and including a surface that is orthogonal to the vehicle width direction, a front wall portion extending from a front end of the bottom portion in a vehicle front/rear direction towards a vehicle outer side and a rear wall portion extending from a rear end of the bottom portion in the vehicle front/rear direction towards the vehicle outer side.

4. The door sash for the vehicle according to claim 3, wherein
the recessed portion includes a step formed in the vehicle width direction and provided between the bottom portion and the rear wall portion, and
the recessed portion is formed by restraining the rear wall portion and by press-forming the bottom portion, the press-forming being started from the step which is used as a starting point of bending.

5. The door sash for the vehicle according to claim 1, wherein an opening edge of the recessed portion is joined to the cover portion of by projection welding.

6. A method for manufacturing a door sash for a vehicle, the door sash configured to include a column portion extending in an elongated configuration from an upper surface of a door panel of the vehicle towards an upper direction, the column portion including a main portion which is made of a piece of metal plate and is formed in an elongated configuration, the main portion including a recessed portion which is recessed in a vehicle width direction and is provided in a long-side direction of the main portion, the column portion including a glass run channel portion which is made of a piece of metal plate and is formed in an elongated configuration, the glass run channel portion being assembled on the main portion in a manner that a long-side direction of the glass run channel portion coincides with the long-side direction of the main portion, the glass run channel portion including a cover portion covering an opening surface of the recessed portion, the glass run channel portion being configured to be mounted with a glass run for guiding movement of a door glass which is movably attached to the door panel, the method for manufacturing the door sash for the vehicle comprising:
a roll process for forming an intermediate formed product by roll-forming a metal plate including an elongated shape, the intermediate formed product being formed in an elongated shape and including a constant cross-sectional configuration at which a weather strip channel portion is formed, a weather strip for sealing a gap between a body of the vehicle and the column portion being attached to the weather strip channel portion; and
a press process for forming the recessed portion at an unrestrained portion which is not restrained, the recessed portion being recessed in a direction that is orthogonal to a long-side direction of the intermediate formed product and including a portion at which a depth of a recess is continuously changed in the long-side direction, wherein the unrestrained portion which is not restrained is pressed by a punch while a restrained portion including the weather strip channel portion formed at the intermediate formed product is restrained by a die in the press process.

7. The method for manufacturing the door sash for the vehicle according to claim 6, wherein the recessed portion is formed in the press process so as to include a portion at which a depth of the recessed portion continuously increases from a first side to a second side in the long-side direction of the intermediate formed product.

8. The method for manufacturing the door sash for the vehicle according to claim 7, further comprising:
a trimming process for forming the main portion by trimming the unrestrained portion so that an end edge of the unrestrained portion along the long-side direction of the intermediate formed product is horizontal relative to the long-side direction of the intermediate formed product, the trimming process being conducted after the press process is conducted.

9. The method for manufacturing the door sash for the vehicle according to claim 7, wherein a step is formed in the roll process, the step is formed in a pressing direction of the punch and is provided at a boundary portion between the unrestrained portion which is pressed by the punch in the press process and the restrained portion which is not pressed by the punch in the press process, the press process being conducted after the roll process is conducted.

10. The method for manufacturing the door sash for the vehicle according to claim 8, further comprising:
a glass run channel forming process for forming a glass run channel portion by roll-forming a metal plate formed in an elongated shape, the glass run channel portion being mounted with a glass run for guiding movement of a door glass which is movably attached to the door panel;
an assembly process for assembling the main portion and the glass run channel portion on each other so that an opening surface of the recessed portion is covered with the glass run channel portion; and
a joining process for joining an opening edge of the recessed portion of the main portion and the glass run channel portion by projection welding, the main portion and the glass run channel portion being assembled on each other in the assembly process.
